(19) United States
(12) Patent Application Publication
(10) Pub. No.: US 2026/0268373 A1
(43) Pub. Date: Sep. 10, 2026

(54) INFORMATION PRESENTATION APPARATUS, INFORMATION PRESENTATION METHOD, AND NON-TRANSITORY COMPUTER READABLE MEDIUM FOR INFORMATION PRESENTATION PROGRAM

(71) Applicant: Honda Motor Co., Lt.d, Tokyo (JP)

(72) Inventors: Kazuki Yoshigai, Tokyo (JP); Yosuke Fuchiwaki, Tokyo (JP); Hiroshi Honda, Tokyo (JP); Ko Uchida, Tokyo (JP); Tameaki Honda, Tokyo (JP); Shotaro Nishimura, Tokyo (JP)

(21) Appl. No.: 19/554,658

(22) Filed: Mar. 3, 2026

(30) Foreign Application Priority Data
Mar. 6, 2025 (JP) 2025-035258

(51) Int. Cl. G06Q 30/0251; G06F 40/40; G06T 11/60

(52) U.S. Cl. CPC G06Q 30/0271; G06F 40/40; G06T 11/60

(57) ABSTRACT

An information presentation apparatus includes: a microprocessor; and a memory connected to the microprocessor. The microprocessor is configured to perform: acquiring request information indicating a request of a user for a service including provision of a merchandise or labor; when acquiring the request information, acquiring preference information regarding preference of the user for the merchandise or the labor; generating an image of the merchandise or the labor according to the request of the user based on the preference information acquired; and outputting the image to a display device.

### CROSS-REFERENCE TO RELATED APPLICATION

This application is based upon and claims the benefit of priority from Japanese Patent Application No. 2025-035258 filed on Mar. 06, 2025, the content of which is incorporated herein by reference.

### BACKGROUND

### Technical Field

The present disclosure relates to an information presentation apparatus, an information presentation method, and a non-transitory computer readable medium for an information presentation program for presenting information.

### Related Art

Conventionally, a device that presents, to a user, image data reflecting customization contents selectable at the time of selling a used vehicle has been disclosed (see e.g., JP 2002-87184 A). The device described in JP 2002-87184 A generates image data reflecting customization contents based on base model data corresponding to a vehicle type and a grade of a used vehicle and customization candidate data selected by a user.

However, in the device described in JP 2002-87184 A, it is necessary for the user to select the customization contents, which is a burden on the user.

### SUMMARY

An aspect of the present invention is an information presentation apparatus including: a microprocessor; and a memory connected to the microprocessor. The microprocessor is configured to perform: acquiring request information indicating a request of a user for a service including provision of a merchandise or labor; when acquiring the request information, acquiring preference information regarding preference of the user for the merchandise or the labor; generating an image of the merchandise or the labor according to the request of the user based on the preference information acquired; and outputting the image to a display device.

Another aspect of the present invention is an information presentation method including: acquiring request information indicating a request of a user for a service including provision of a merchandise or labor; when acquiring the request information, acquiring preference information regarding preference of the user for the merchandise or the labor: generating an image of the merchandise or the labor according to the request of the user based on the preference information acquired; and outputting the image to a display device.

Still another aspect of the present invention is a non-transitory computer-readable storage medium storing an information presentation program for presenting information, the information presentation program configured to be executed by a computer. The information presentation program causes the computer to perform: acquiring request information indicating a request of a user for a service including provision of a merchandise or labor; when acquiring the request information, acquiring preference information regarding preference of the user for the merchandise or the labor: generating an image of the merchandise or the labor according to the request of the user based on the preference information acquired; and outputting the image to a display device.

### BRIEF DESCRIPTION OF THE DRAWINGS

The objects, features, and advantages of the present invention will become clearer from the following description of embodiments in relation to the attached drawings, in which:

FIG. 1 is a block diagram schematically illustrating an entire configuration of information presentation system including an information presentation apparatus according to an embodiment of the present invention;

FIG. 2A is a block diagram illustrating a main configuration of the information presentation apparatus in FIG. 1;

FIG. 2B is a diagram for describing a configuration of a main part of the image generation unit in FIG. 2;

FIG. 3A is a diagram illustrating an example of an image generated by the image generation unit;

FIG. 3B is a diagram illustrating another example of an image generated by the image generation unit;

FIG. 4 is a block diagram illustrating a configuration of a main part of the user terminal in FIG. 1; and

FIG. 5 is a flowchart illustrating an example of processing executed by the controller in FIG. 2A.

### DETAILED DESCRIPTION

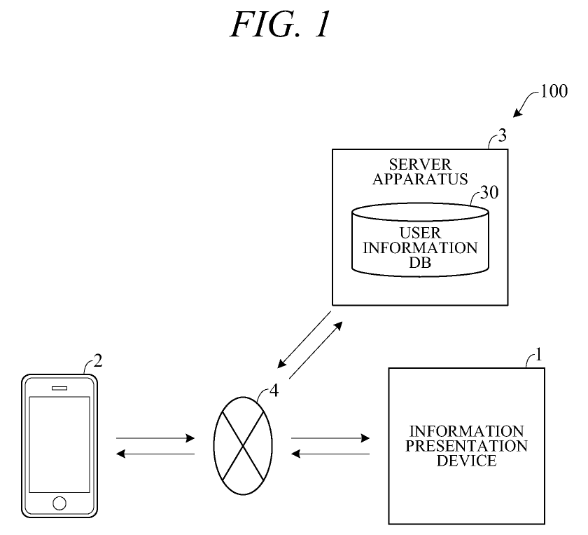

Hereinafter, embodiments of the invention will be described below with reference to the drawings. An information presentation apparatus according to an embodiment of the present invention is a device for presenting information regarding merchandise or labor to a user who is considering use of a service including the provision of the merchandise or the labor. FIG. 1 is a block diagram schematically illustrating an entire configuration of information presentation system 100 including an information presentation apparatus 1 according to the present exemplary embodiment. As illustrated in FIG. 1, the information presentation system 100 includes an information presentation apparatus 1, a user terminal 2, and a server apparatus 3. The server apparatus 3 is managed by, for example, a business operator (vehicle dealer etc.) that provides services.

The information presentation apparatus 1, the user terminal 2, and the server apparatus 3 are communicably connected by a communication network 4. The communication network 4 includes not only a public wireless communication network represented by the Internet network, a mobile telephone network, or the like but also a closed communication network provided for every predetermined management region, for example, a wireless LAN, Wi-Fi (registered trademark), Bluetooth (registered trademark), or the like.

The user terminal 2 is a communication terminal such as a smartphone used by a user who uses a service. Note that, although FIG. 1 illustrates one user terminal 2, in a case where there are a plurality of users who use a service, the information presentation system 100 includes user terminals 2 corresponding to each of the users.

The server apparatus 3 includes a user information database (hereinafter referred to as DB) 30. The user information DB 30 stores user information of each user who uses the service. The user information includes identification information (hereinafter referred to as user ID) of the user, identification information (hereinafter referred to as a terminal ID) of the user terminal 2 used by the user, service usage information indicating a use history of the service of the user, and information (hereinafter referred to as preference information) indicating a preference of the user with respect to the merchandise or the labor. The service usage information includes information indicating a purchase history of merchandise and a use history of labor. The preference information will be described later.

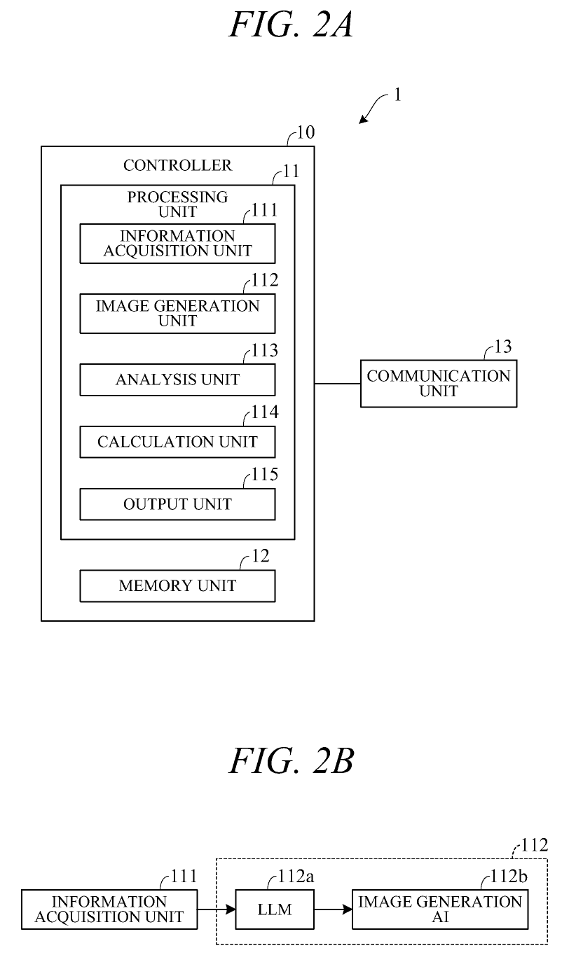

FIG. 2A is a block diagram illustrating a main configuration of the information presentation apparatus 1 in FIG. 1. The information presentation apparatus 1 includes a controller 10 and a communication unit 13.

The communication unit 13 is a communication interface that connects the information presentation apparatus 1 to the communication network 4. The information presentation apparatus 1 transmits and receives information to and from the user terminal 2 connected to the communication network 4 via the communication unit 13.

The controller 10 includes a computer including an arithmetic unit 11 such as a CPU (microprocessor), a storage unit 12 such as a ROM and a RAM, and other peripheral circuits (not illustrated) such as an I/O interface. The arithmetic unit 11 functions as an information acquisition unit 111, an image generation unit 112, an analysis unit 113, a calculation unit 114, and an output unit 115 by executing a program stored in the storage unit 12.

The information acquisition unit 111 acquires information (hereinafter referred to as request information) indicating a request of the user for the service. The request information is text information indicating a request of the user for merchandise or labor, such as “I want to buy a car” or “I want to go to a restaurant”. The information acquisition unit 111 acquires (receives) the request information transmitted from the user terminal 2 via the communication unit 13. The request information is accompanied by the user ID of the user who uses the user terminal 2 of the transmission source. Note that the request information may be accompanied by a terminal ID of the user terminal 2 of the transmission source instead of the user ID or together with the user ID.

Furthermore, the information acquisition unit 111 specifies a target (merchandise or labor) requested to be provided based on a request of the user based on the request information received from the user terminal 2. The specified type of merchandise or labor is referred to as the target merchandise or target labor. Specification of the target merchandise or the target labor is performed by using a large-scale language model (LLM). The LLM is a machine learning model that understands text and generates text. As a result, the target merchandise or the target labor can be specified from the request information described in natural language such as “I want to buy a car” or “I want to go to a restaurant”.

When the target merchandise or the target labor is specified, the information acquisition unit 111 estimates the preference of the user for the target merchandise or the target labor. When the target merchandise is a “car”, examples of the preference for the target merchandise include a red car, a sporty design car, a car suitable for outdoors, a car suitable for seaside, and the like. When the target labor is “serving pancake”, examples of the preference for the target labor include a relaxed cafe where pancakes are served, a restaurant where fluffy pancakes are served, and the like.

The information acquisition unit 111 estimates the preference of the user for the target merchandise or the target labor based on the information (hereinafter referred to as recorded information) recorded in the user terminal 2. Specifically, the information acquisition unit 111 transmits a command requesting for transmission of the recorded information to the user terminal 2 via the communication unit 13, and estimates the preference of the user based on the recorded information transmitted from the user terminal 2 in response to the command.

The recorded information includes information (hereinafter referred to as tracking information) tracked by an application (hereinafter referred to as an app) installed in the user terminal 2. The tracking information includes, for example, a web browsing history, a merchandise purchase history, and a labor use history. In addition, the recorded information includes an imaged image acquired by the imaging device of the user terminal 2. The information acquisition unit 111 extracts information (imaged image, purchase history, use history, etc.) related to the target merchandise or the target labor from the recorded information, and estimates the preference of the user for the target merchandise or the target labor based on the extracted information.

Note that information acquisition unit 111 may acquire information (hereinafter referred to as SNS information) related to the target merchandise or the target labor disclosed on a social networking service (SNS) by the user. Then, the information acquisition unit 111 may estimate the preference of the user for the target merchandise or the target labor based on the acquired SNS information.

A method for acquiring the SNS information will be described. First, the information acquisition unit 111 acquires account information of the SNS recorded in the user terminal 2. More specifically, the information acquisition unit 111 transmits a command requesting for transmission of the account information to the user terminal 2 via the communication unit 13, and receives the account information transmitted from the user terminal 2 in response to the command. The account information includes, for example, an account name of the user. Next, the information acquisition unit 111 acquires the account name of the user from the received account information. Finally, the information acquisition unit 111 accesses an SNS operated on the server apparatus 3 or an external server (cloud server, etc.) (not illustrated) via the communication unit 13, and extracts information related to the target merchandise or the target labor from the information disclosed with the account name of the user. Note that the above-described method for acquiring the SNS information is an example, and the SNS information may be acquired by another method.

In addition, the information acquisition unit 111 may acquire the service usage information associated with the user ID of the user from the user information DB 30 of the server apparatus 3 via the communication unit 13, and estimate the preference of the user for the target merchandise or the target labor based on the acquired service usage information.

When estimating the preference of the user as described above, the information acquisition unit 111 acquires the estimation result as preference information. The information acquisition unit 111 transmits the acquired preference information to the user information DB 30 of the server apparatus 3 together with the user ID. As a result, the preference information is stored in the user information DB 30 together with the user ID. Note that, in a case where preference information corresponding to the same user ID has already been stored in the user information DB 30, the preference information is updated.

The image generation unit 112 generates an image of the target merchandise or the target labor, more specifically, image information indicating an image of the target merchandise or the target labor based on the preference information acquired by the information acquisition unit 111. The image information is generated by using a machine learning model. Specifically, first, the image generation unit 112 generates a prompt (instruction sentence) for instructing generation of image information based on the preference information using the LLM. Next, the image generation unit 112 generates image information according to the generated prompt using image generation Artificial Intelligence (AI).

FIG. 2B is a diagram for describing a configuration of a main part of the image generation unit 112. As illustrated in FIG. 2B, the image generation unit 112 includes an LLM 112a and an image generation AI 112b. The LLM 112a generates a prompt for inputting to the image generation AI 112b based on the preference information acquired by the information acquisition unit 111. The image generation AI 112b generates image information of the target merchandise or the target labor according to a prompt input from the LLM 112a.

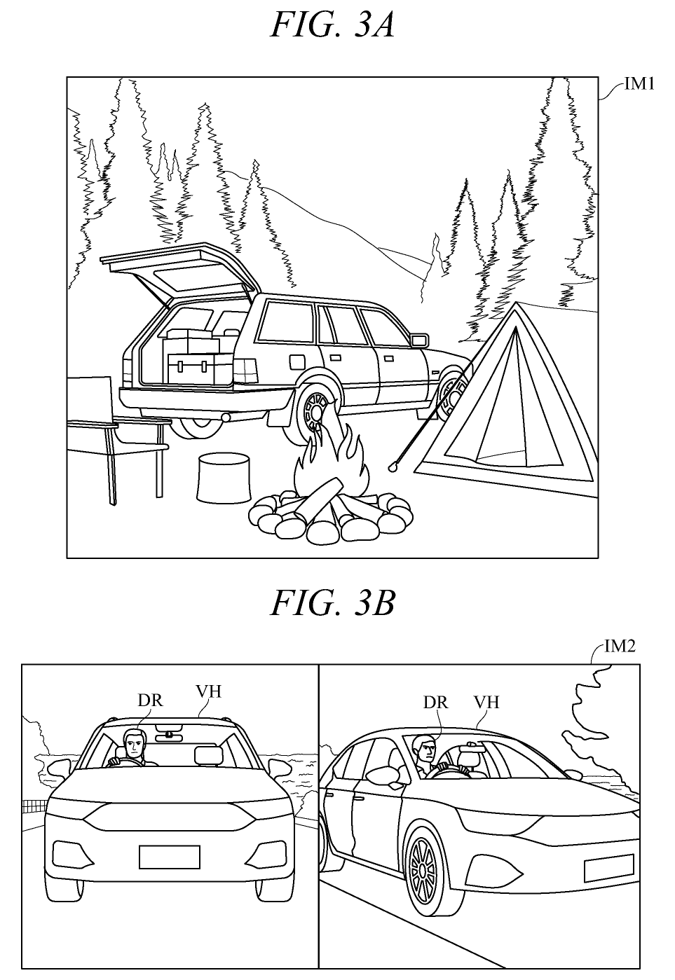

FIGS. 3A and 3B are diagrams illustrating examples of an image (hereinafter referred to as a generated image) indicated by image information generated by the image generation unit 112. FIGS. 3A and 3B illustrate examples of the generated image when the target merchandise is the “car”.

For example, in a case where it is recognized that the user likes the outdoors based on the SNS information of the user, the information acquisition unit 111 estimates “a vehicle suitable for a camping site” as a vehicle suitable for the preference of the user. Then, the information acquisition unit 111 inputs the preference information including the estimation result to the LLM 112a. The LLM 112a generates a prompt of a natural language based on the input preference information. An example of the prompt generated at this time includes “SUV (sports utility vehicles) parked beside a tent in a camping site. Magnificent mountains in the background”. In the case of this example, the image information indicating an image IM1 as illustrated in FIG. 3A is generated in the image generation AI 112b.

Furthermore, for example, in a case where it is recognized that the user likes to drive to the seaside based on the SNS information of the user, the information acquisition unit 111 estimates a “car suitable for seaside” as a car suitable for the preference of the user. An example of the prompt generated by the LLM 112a at this time is “Stylish car traveling on a roadway along the sea. Quiet blue sea in the background”. In this case, the image information indicating the image IM2 as illustrated in FIG. 3B is generated in the image generation AI 112b.

As described above, the prompt generated by the LLM 112a includes the text designating the attributes of the target merchandise and the target labor. The attribute of the target merchandise includes a type (car, motorcycle, etc.), a characteristic (model, color, size, etc.), and a use environment (usage place, usage time zone, weather, etc.) of the target merchandise. In addition, the attribute of the target labor includes a type (restaurant business, etc.), a type of a merchandise to be served (pancake, ramen, etc.), a characteristic of the merchandise to be served, and a serving environment (serving place, serving time zone, weather, etc.) of the target labor. Note that the attribute of the target merchandise and the attribute of the target labor are not limited thereto, and other information may be included.

When generating an image, the image generation unit 112 may create a plurality of image generation modes corresponding to the target merchandise or the target labor based on the request information acquired by the information acquisition unit 111 and present the image generation modes to the user.

For example, when the user's request indicated by the request information is “I want to buy a car”, the image generation unit 112 creates image generation modes corresponding to a plurality of travel environments (in city, suburb, highway, tunnel, wilderness, etc.). In this case, as the image generation modes, a city travel mode, a suburb travel mode, an expressway travel mode, a tunnel travel mode, a wilderness travel mode, and the like are created.

Note that image generation modes corresponding to a plurality of vehicle categories (sports type, outdoor type, one-box type, etc.), a plurality of vehicle body colors, a plurality of vehicle body sizes, and the like may be created. Furthermore, an image generation mode incorporating an entertainment element may be created. As an example, image generation modes corresponding to a plurality of types of drivers (F1 racer, MotoGP rider, rally car driver, classic car owner, etc.) may be created. In this case, as the image generation modes, an F1 mode, a MotoGP mode, a rally mode, a classic car mode, and the like are created.

Furthermore, for example, in a case where the user's request indicated by the request information is “I want to eat pancake”, the image generation unit 112 creates image generation modes corresponding to a plurality of scenes (retro cafe, high-end restaurant, family restaurant, sweets cafe, etc.). In this case, as the image generation mode, a retro cafe mode, a high-end restaurant mode, a family restaurant mode, a sweets cafe mode, and the like are created. Image generation modes corresponding to a plurality of offering styles (fluffy dough, fruit topping, more cream, etc.) may be created.

The image generation unit 112 transmits information (hereinafter referred to as mode information) indicating the created plurality of image generation modes and a selection command of the image generation mode (hereinafter referred to as a mode selection command) to the user terminal 2 via the communication unit 13. The image generation unit 112 receives the selection result information including the selection result of the image generation mode transmitted from the user terminal 2 as a response to the mode selection command. The image generation unit 112 generates image information based on the preference information according to the image generation mode indicated by the selection result information. For example, when the image generation mode is the F1 mode, the image information is generated such that the vehicle and the driver included in the image are represented as the F1 machine and the F1 driver.

The analysis unit 113 analyzes the image information of the target merchandise or the target labor generated by the image generation unit 112, and specifies the attribute of the target merchandise or the target labor. In a case where the target requested to be provided based on the request of the user is a merchandise, the image information generated by the image generation unit 112 is analyzed to specify the type, characteristic, and use environment of the target merchandise indicated by the image information. Furthermore, in a case where the target requested to be provided based on the request of the user is labor, the analysis unit 113 analyzes the image information generated by the image generation unit 112, and specifies the type of the target labor, the type of the provided merchandise, the characteristic of the provided merchandise, and the providing environment indicated by the image information.

The calculation unit 114 calculates a matching degree between the attribute of the target merchandise or the target labor specified by the preference information acquired by the information acquisition unit 111 and the attribute of the target merchandise or the target labor specified by the analysis unit 113.

Specifically, the calculation unit 114 compares the attribute of the target merchandise specified by the preference information with the attribute of the target merchandise specified by the analysis unit 113 for each attribute classification (type, characteristic, and use environment). Then, the calculation unit 114 calculates a ratio of the number of matching classifications with respect to the total number of classifications (in this case, three) as the matching degree. Similarly, the calculation unit 114 compares the attribute of the target merchandise specified by the preference information with the attribute of the target labor specified by the analysis unit 113 for each attribute classification (type of target labor, type of provided merchandise, characteristic of provided merchandise, and providing environment), and calculates a ratio of the number of matching classifications with respect to the total number of classifications (in this case, four) as the matching degree. Note that the method of calculating the matching degree of the attributes is not limited thereto.

The output unit 115 outputs the image information generated by the image generation unit 112 when the matching degree calculated by the calculation unit 114 is equal to or greater than a predetermined degree. Specifically, the output unit 115 transmits image information and a display command for the image information to the user terminal 2 via the communication unit 13. Note that the output unit 115 may output the image information generated by the image generation unit 112 when the matching degree is 100%, that is, when the matching degree is perfect matching.

When transmitting the image information to the user terminal 2, the output unit 115 may transmit an evaluation command for requesting evaluation on the image information in association with the image information. When receiving the evaluation information including the evaluation result transmitted from the user terminal 2 as a response to the evaluation command, the image generation unit 112 regenerates the image information based on the evaluation information. When the image information is regenerated, the output unit 115 transmits the regenerated image information to the user terminal 2 again.

The evaluation information includes satisfaction level information indicating a satisfaction level (satisfactory (good) or dissatisfactory (bad)) of the user with respect to the generated image, and information indicating an additional request of the user with respect to the generated image (hereinafter referred to as additional information). The additional information includes additional information indicating an additional request such as “Please generate another image”, “A cooler car is better”, or “A cafe of more relaxed atmosphere is better”. Furthermore, the additional information may include concern information indicating concerns such as “the design of the car does not match the preference” and “the color of the background is too dark”.

When the evaluation information includes the satisfaction level information indicating dissatisfaction, the information acquisition unit 111 re-acquires the preference information. Specifically, the information acquisition unit 111 estimates the preference of the user again based on the recorded information, and updates the preference information based on the estimation result. Note that SNS information or service usage information may be used to update the preference information. The image generation unit 112 regenerates the image information of the target merchandise or the target labor based on the updated preference information.

Furthermore, when the evaluation information includes the additional information and the concern information, the information acquisition unit 111 estimates the preference of the user again based on the additional information and the concern information, and updates the preference information based on the estimation result. The image generation unit 112 regenerates the image information of the target merchandise or the target labor based on the updated preference information.

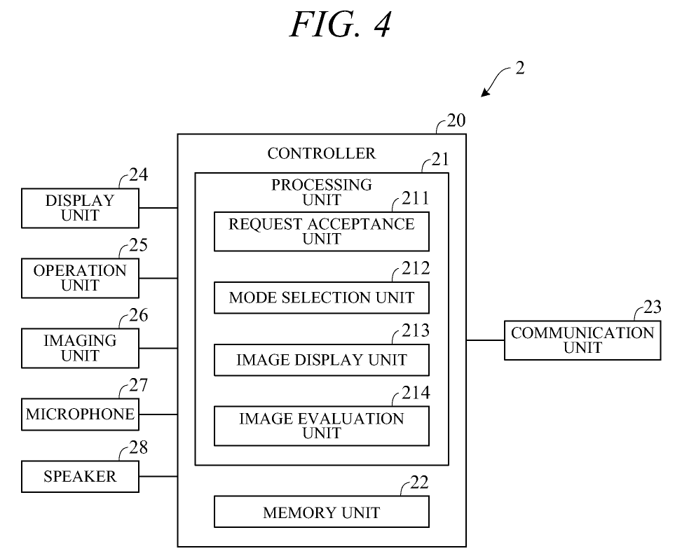

FIG. 4 is a block diagram illustrating a configuration of a main part of the user terminal 2 in FIG. 1. The user terminal 2 includes a controller 20, a communication unit 23, a display unit 24, an operation unit 25, an imaging unit 26, a microphone (hereinafter simply referred to as a mic) 27, and a speaker 28. The storage unit 22 stores programs for various types of control and information such as threshold values used in the programs.

The communication unit 23 is a communication interface that connects the user terminal 2 to the communication network 4. The display unit 24 includes a display device such as a liquid crystal display or an organic EL display including a touch panel. The operation unit 25 includes a touch panel included in the display unit 24, and is capable of inputting various instructions from the user.

The imaging unit 26 includes a camera having an imaging element such as a CCD or a CMOS. The imaged image data acquired by the imaging unit 26 is output to an arithmetic unit 21. The microphone 27 receives surrounding voice as a voice signal. The voice signal input by the microphone 27 is output to the arithmetic unit 21 as voice data via an A/D converter (not illustrated). The speaker 28 outputs the voice data from the arithmetic unit 21 as a voice signal via a D/A converter (not illustrated).

The controller 20 includes a computer having an arithmetic unit 21 such as a CPU (microprocessor), the storage unit 22 such as a ROM and a RAM, and other peripheral circuits (not illustrated) such as an I/O interface. The arithmetic unit 21 functions as a request acceptance unit 211, a mode selection unit 212, an image display unit 213, and an image evaluation unit 214 by executing a program stored in the storage unit 22.

The request acceptance unit 211 accepts a request for a service from the user. Specifically, the request acceptance unit 211 generates screen information for accepting input of request information on the display unit 24, and outputs the screen information to the display unit 24. As a result, a request acceptance screen (not illustrated) is displayed on the display unit 24. The request acceptance screen may be displayed when a predetermined application installed in the user terminal 2 is activated, or may be displayed at another timing.

The user operates the request acceptance screen via the operation unit 25 to input the request information. The request acceptance unit 211 transmits the request information input by the user to the information presentation apparatus 1. Note that the request acceptance unit 211 may accept input of request information by voice via the microphone 27. In addition, the request acceptance unit 211 may output a voice prompting the input of the request information via the speaker 28 instead of or together with the display of the request acceptance screen.

Upon receiving the mode selection command and the mode information from the information presentation apparatus 1, the mode selection unit 212 generates screen information for allowing the user to select the image generation mode based on the mode information. The mode selection unit 212 outputs the generated screen information to the display unit 24. As a result, a mode selection screen (not illustrated) is displayed on the display unit 24. A list of a plurality of image generation modes indicated by the mode information is displayed on the mode selection screen.

The user operates the mode selection screen via the operation unit 25 to select one of the image generation modes from the list displayed on the mode selection screen. The mode selection unit 212 transmits selection result information indicating the image generation mode selected by the user to the information presentation apparatus 1. In a case where the operation indicating that the selection of the image generation mode is unnecessary is performed on the mode selection screen, the selection result information indicating that the image generation mode is not selected is transmitted to the information presentation apparatus 1.

Upon receiving the display command and the image information from the information presentation apparatus 1, the image display unit 213 outputs the received image information to the display unit 24. As a result, the generated image as illustrated in FIGS. 3A and 3B is displayed on the display unit 24.

Upon receiving the evaluation command and the image information from the information presentation apparatus 1, the image evaluation unit 214 evaluates the received image information. Specifically, the image evaluation unit 214 outputs the received image information to the display unit 24, and outputs screen information for inputting an evaluation result of the image (generated image) displayed on the display unit 24 to the display unit 24. As a result, an evaluation result input screen (not illustrated) is displayed on the display unit 24.

The user operates the evaluation result input screen via the operation unit 25 to input the evaluation result of the generated image displayed on the display unit 24. The image evaluation unit 214 transmits the evaluation information including the input evaluation result to the information presentation apparatus 1. Note that the image evaluation unit 214 may accept an input of an evaluation result by voice via the microphone 27. In addition, the image evaluation unit 214 may output, via the speaker 28, a voice prompting the evaluation of the generated image displayed on the display unit 24, instead of the display of the evaluation result input screen or together with the display of the evaluation result input screen.

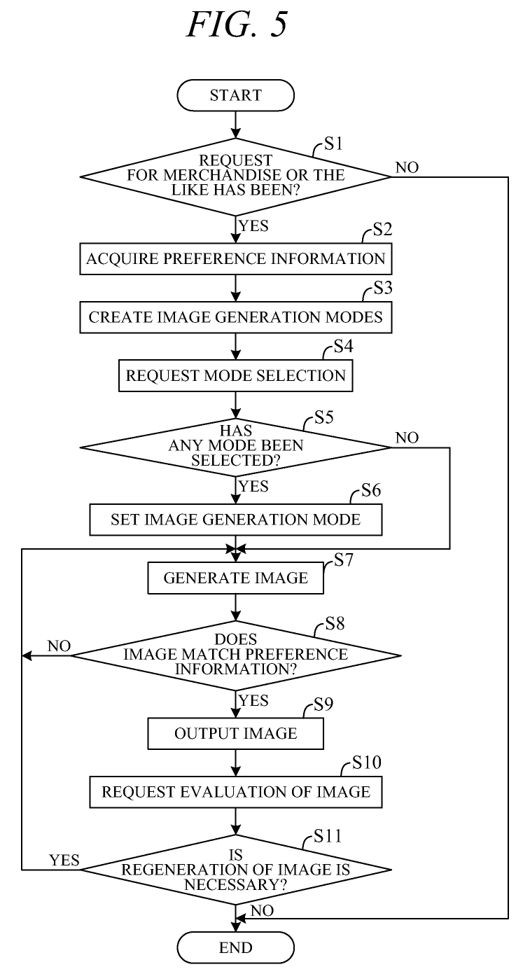

FIG. 5 is a flowchart illustrating an example of processing executed by the controller 10 of the information presentation apparatus 1 according to a program defined in advance. The processing illustrated in the flowchart is started when the controller 10 is activated, and is repeated at a predetermined cycle.

First, in step S1, the controller 10 determines whether or not request information has been received from the user terminal 2. When a negative determination is made in step S1, the controller 10 ends the processing. When an affirmative determination is made in step S1, in step S2, the controller 10 specifies a target (merchandise or labor) requested to be provided based on the request of the user, that is, the target merchandise or the target labor based on the request information received in step S1. Then, the controller 10 acquires preference information indicating the preference of the user with respect to the target merchandise or the target labor.

In step S3, the controller 10 creates a plurality of image generation modes corresponding to the target merchandise or the target labor based on the request information received in step S1. In step S4, the controller 10 transmits a mode selection command to the user terminal 2 together with the mode information indicating the plurality of image generation modes created in step S3.

In step S5, when receiving the selection result information transmitted from the user terminal 2 as a response to the mode selection command, the controller 10 determines whether or not the image generation mode is selected based on the selection result information. When a negative determination is made in step S5, the controller 10 proceeds to the processing in step S7.

When an affirmative determination is made in step S5, the controller 10 sets the image generation mode based on the selection result information in step S6. Specifically, information (hereinafter referred to as mode setting information) indicating the image generation mode indicated by the selection result information is stored in the storage unit 12.

In step S7, the controller 10 generates image information of the target merchandise or the target labor based on the preference information acquired in step S3. At this time, in a case where the mode setting information is stored in the storage unit 12, an image is generated according to the mode setting information.

In step S8, the controller 10 determines whether or not the image information generated in step S7 matches the preference information acquired in step S3. More specifically, the controller 10 analyzes the image information of the target merchandise or the target labor generated in step S7 to specify the attribute of the target merchandise or the target labor. In addition, the controller 10 calculates a matching degree between the specified attribute of the target merchandise or the target labor and the attribute of the target merchandise or the target labor specified by the preference information. Furthermore, the controller 10 determines whether or not the calculated matching degree is equal to or greater than a predetermined degree.

When a negative determination is made in step S8, the controller 10 returns to the processing in step S7 and regenerates the image information. When an affirmative determination is made in step S8, in step S9, the controller 10 outputs (transmits) the image information generated in step S7 to the user terminal 2 together with the display command.

In step S10, the controller 10 transmits an evaluation command for requesting evaluation of the generated image to the user terminal 2. When receiving the evaluation information including the evaluation result transmitted from the user terminal 2 as a response to the evaluation command, in step S11, the controller 10 determines whether or not the regeneration of the image information is necessary based on the evaluation information.

In a case where the evaluation information includes the satisfaction level information indicating dissatisfaction with respect to the generated image, an affirmative determination is made in step S11, and the controller 10 returns to the processing of step S7 and regenerates the image information. Even in a case where the evaluation information includes the additional information or the concern information, an affirmative determination is made in step S11. In this case, the controller 10 returns to the processing of step S7 and regenerates the image information according to the additional information or the concern information.

On the other hand, in a case where the evaluation information includes the satisfaction level information indicating the satisfaction with respect to the generated image and does not include the additional information nor the concern information, a negative determination is made in step S11, and the controller 10 ends the processing.

According to the above-described embodiment, the following effects can be achieved.
(1) The information presentation apparatus 1 includes an information acquisition unit 111 for acquiring request information indicating a request of a user for a service including provision of a merchandise or labor and, when acquiring the request information, acquiring preference information regarding preference of the user for the merchandise or the labor, an image generation unit 112 for generating an image of the merchandise or the labor according to the request of the user based on the preference information acquired by the information acquisition unit 111, and an output unit 115 for outputting the image (generated image) generated by the image generation unit 112 to a display device (e.g., the display unit 24 of the user terminal 2). Thus, it is possible to present a sales promotion image (promotion image) matching the user's preference without imposing a burden on the user. As a result, the sales promotion effect can be improved. In addition, since the promotion image can be easily generated, sales promotion advertisement cost of merchandise or the labor can be reduced.
(2) The information acquisition unit 111 acquires preference information indicating preference of the user for merchandise or labor corresponding to the request of the user based on the request information. As a result, it is possible to present a promotion image matching the user's preference based on the user's request for the service, and it is possible to further improve the sales promotion effect.
(3) The information presentation apparatus 1 further includes the communication unit 13. The information acquisition unit 111 acquires the information regarding the merchandise or the labor stored in the storage unit 22 of the user terminal 2 via the communication unit 13, estimates the preference of the user for the merchandise or the labor based on the acquired information, and acquires the preference information. Furthermore, the information acquisition unit 111 may acquire information regarding merchandise or labor disclosed on the social media network by the user via the communication unit 13, estimate the preference of the user for merchandise or the labor based on the acquired information, and acquire the preference information. As a result, a promotion image more suitable for the user's preference can be presented. (
4) The communication unit 13 is communicably connected to the server apparatus 3 that stores service usage information indicating a purchase history of merchandise or a use history of labor. The server apparatus 3 stores service usage information corresponding to a plurality of users. The information acquisition unit 111 acquires the service usage information corresponding to the user from the server apparatus 3 via the communication unit 13, estimates the preference of the user for the merchandise or the labor based on the service usage information, and acquires the preference information. As a result, since the preference of the user for the merchandise or the labor is estimated based on the service use history of the user acquired from the server apparatus 3 managed by the business operator (vehicle dealer etc.) that provides the service, the sales promotion effect of the business operator can be improved.
(5) The image generation unit 112 generates a prompt for instructing generation of an image based on the preference information using LLM, and generates an image according to the generated prompt using the image generation AI. As a result, an image is generated according to a prompt describing the user's preference in a natural language, and a promotion image more suitable for the user's preference can be generated.
(6) The information presentation apparatus 1 further includes an analysis unit 113 for analyzing the image of the merchandise or the labor generated by the image generation unit 112 to specify the attribute of the merchandise or the labor. The output unit 115 outputs the image to the display device when the matching degree between the attribute of the merchandise or the labor specified by the preference information acquired by the information acquisition unit 111 and the attribute of the merchandise or the labor specified by the analysis unit 113 is equal to or greater than a predetermined degree. As a result, it is possible to prevent a promotion image not suitable for the user's preference from being presented, and it is possible to suppress a reduction in sales promotion effect.
(7) The information acquisition unit 111 further acquires, as an evaluation information acquisition unit, evaluation information indicating the evaluation of the user on the image (first image) generated by the image generation unit 112. The evaluation information includes additional information regarding the user's preference for the merchandise or the labor. The image generation unit 112 regenerates the image based on the first image and the evaluation information acquired by the information acquisition unit 111. The output unit 115 outputs the regenerated image (second image) to the display device. As a result, it is possible to present a promotion image reflecting the evaluation of the user.
(8) The image generation unit 112 further creates, based on the request information acquired by the information acquisition unit 111, a plurality of image generation modes corresponding to the merchandise or the labor. The image generation unit 112 transmits a mode selection command for allowing the user to select one of the plurality of image generation modes to the user terminal 2, and generates an image according to the image generation mode indicated by the selection result information transmitted from the user terminal 2 as a response to the mode selection command. In this manner, a promotion image more suitable for the user's preference can be generated by presenting the image generation mode to the user in advance. Furthermore, since the regeneration of the image is suppressed, the convenience of the user can be improved.

The above-described embodiments may be modified into various modes. Hereinafter, modified examples will be described. In the above-described embodiment, the case where the image generation unit 112 includes the LLM 112a and the image generation AI 112b has been described as an example. However, the image generation unit may generate an image based on the preference information using the LLM and the image generation AI included in the external server.

In the above-described embodiment, the image generation unit 112 generates the image of the target merchandise or the target labor based on the preference information acquired by the information acquisition unit 111 serving as the preference information acquisition unit. However, the information acquisition unit 111 serving as a face image acquisition unit may transmit a command for requesting transmission of image information (hereinafter referred to as face image information) indicating the face image of the user to the user terminal 2 via the communication unit 13, and acquire the face image information transmitted from the user terminal 2 in response to the command. Then, the image generation unit may generate the image such that the face image of the user is included in the image indicated by the generated image based on the face image information acquired by the face image acquisition unit. As a result, when the generated image includes the face image of the person who uses the merchandise or the person who utilizes the labor, the face image is replaced with the face image of the user. In the example of the image IM2 in FIG. 3B, the face image of the driver DR is replaced with the face image of the user. As a result, the user can easily have an image that he/she is actually driving the vehicle VH, and the user's willingness to purchase can be increased.

Note that the face image acquisition unit may search for and acquire the face image information of the user from the recorded information or the SNS information. Furthermore, in a case where the face image information of the user is stored in the user information DB 30 in association with the user ID, the face image acquisition unit may acquire the face image information of the user from the user information DB 30.

Furthermore, in the above-described embodiment, the image generation unit 112 generates an image of a merchandise or labor according to the request of the user based on the request information acquired by the information acquisition unit 111 serving as the request information acquisition unit. However, the image generation unit may update the generated image based on the additional request information when the additional request information indicating the additional request of the user is acquired by the request information acquisition unit after the generated image is output by the output unit 115. The additional request information is “Wheel of the vehicle (in the image) is preferably black” or the like.

Furthermore, in the above-described embodiment, the image generation unit 112 serving as a mode creation unit creates a plurality of image generation modes corresponding to a merchandise or labor, and transmits a mode selection command for the user to select one of the plurality of created image generation modes to the user terminal 2. Note that the mode creation unit may determine the presentation order of the plurality of created image generation modes, and include information indicating the determined presentation order in the mode selection command.

The presentation order is determined in consideration of the convenience of the user. For example, in a case where an image generation mode corresponding to a plurality of scenes (a cafe or a restaurant) is created for the user's request “I want to eat pancake”, the mode creation unit determines the presentation order as follows. First, the mode creation unit acquires position information from the user terminal 2. Specifically, the mode creation unit transmits a command requesting for the position information to the user terminal 2, and acquires a sensor value of a position measurement sensor (not illustrated) of the user terminal 2 transmitted from the user terminal 2 in response to the command as the position information of the user terminal 2. Next, the mode creation unit determines the presentation order such that the presentation is sequentially made from the image generation mode corresponding to the cafe or restaurant closer to the current position of the user terminal 2 indicated by the acquired position information. As a result, on the mode selection screen, the image generation modes in high rank in the presentation order are displayed in order from the top. Note that the presentation order may be determined based on information other than the current position of the user terminal 2.

Furthermore, in the above-described embodiment, the output unit 115 outputs the image generated by the image generation unit 112 to the display unit 24 of the user terminal 2 serving as an output device. However, the output unit may output the image generated by the image generation unit 112 to a display device other than the display unit 24 of the user terminal 2. For example, the output unit may output an image to a display of a navigation device mounted on a vehicle or a home television.

The information presentation apparatus according to the above-described embodiment can also be configured as an information presentation method for presenting a promotion image of a merchandise or labor from another viewpoint. That is, the information presentation method can be configured to include a step of acquiring request information indicating a request of the user for a service including provision of a merchandise or labor, a step of acquiring preference information regarding preference of the user when the request information is acquired, a step of generating an image representing the merchandise or the labor related to the request based on the preference information, and a step of outputting the generated image to the display device.

Furthermore, the present invention can be configured by replacing the above-described information presentation method with a program for causing a computer to execute processing of presenting a promotion image of a merchandise or labor. Furthermore, the present invention can be configured by replacing the program with a computer-readable storage medium in which the program is recorded.

The above embodiment can be combined as desired with one or more of the aforesaid modifications. The modifications can also be combined with one another.

According to the present invention, it is possible to present a promotion image that matches user's preference without imposing a burden on the user.

Above, while the present invention has been described with reference to the preferred embodiments thereof, it will be understood, by those skilled in the art, that various changes and modifications may be made thereto without departing from the scope of the appended claims.

What is claimed is:

1. An information presentation apparatus comprising:
a microprocessor; and
a memory connected to the microprocessor, wherein
the microprocessor is configured to perform:
acquiring request information indicating a request of a user for a service including provision of a merchandise or labor;
when acquiring the request information, acquiring preference information regarding preference of the user for the merchandise or the labor;
generating an image of the merchandise or the labor according to the request of the user based on the preference information acquired; and
outputting the image to a display device.

2. The information presentation apparatus according to claim 1, wherein
the microprocessor is configured to perform
the acquiring of the preference information including acquiring the preference information indicating preference of the user for the merchandise or the labor corresponding to the request of the user based on the request information.

3. The information presentation apparatus according to claim 2 further comprising
a communication unit, wherein
the microprocessor is configured to perform
the acquiring of the preference information including acquiring information regarding the merchandise or the labor stored in a storage unit of a user terminal used by the user via the communication unit, and estimating the preference of the user for the merchandise or the labor based on the information acquired to acquire the preference information.

4. The information presentation apparatus according to claim 2 further comprising
a communication unit, wherein
the microprocessor is configured to perform
the acquiring of the preference information including acquiring information regarding the merchandise or the labor disclosed on a social media network by the user via the communication unit, and estimating the preference of the user for the merchandise or the labor based on the information acquired to acquire the preference information.

5. The information presentation apparatus according to claim 2 further comprising
a communication unit configured to communicably connect to a server apparatus storing service usage information indicating a usage history of the merchandise or a use history of the labor, wherein
the server apparatus stores service usage information corresponding to a plurality of users, and
the microprocessor is configured to perform
the acquiring of the preference information including acquiring the service usage information corresponding to the user from the server apparatus via the communication unit, and estimating the preference of the user for the merchandise or the labor based on the service usage information to acquire the preference information.

6. The information presentation apparatus according to claim 2, wherein
the microprocessor is configured to perform
the generating including generating a prompt for instructing generation of the image based on the preference information using a LLM (large-scale language model), and generating the image according to the prompt using an image generation AI (Artificial Intelligence).

7. The information presentation apparatus according to claim 6, wherein
the microprocessor is configured to further perform:
analyzing the image of the merchandise or the labor generated to specify an attribute of the merchandise or the labor; and
outputting the image to the display device when a matching degree between the attribute of the merchandise or the labor specified and an attribute of the merchandise or the labor specified by the preference information is equal to or greater than a predetermined degree.

8. The information presentation apparatus according to claim 1, wherein
the image is a first image,
the microprocessor is configured to further perform:
acquiring evaluation information indicating an evaluation of the user on the first image;
generating a second image based on the first image and the evaluation information; and
outputting the second image to the display device.

9. The information presentation apparatus according to claim 8, wherein
the evaluation information includes additional information regarding the preference of the user for the merchandise or the labor.

10. The information presentation apparatus according to claim 1, wherein
the microprocessor is configured to further perform:
acquiring face image information indicating a face image of the user; and
generating the image of the merchandise or the labor such that the face image of the user is included in the image of the merchandise or the labor based on the face image information.

11. The information presentation apparatus according to claim 1, wherein
the microprocessor is configured to further perform:
creating, based on the request information, a plurality of image generation modes corresponding to the merchandise or the labor;
transmitting a mode selection command for allowing the user to select one of the plurality of image generation modes to a user terminal used by the user; and
generating the image according to an image generation mode indicated by selection result information transmitted from the user terminal as a response to the mode selection command.

12. The information presentation apparatus according to claim 1, wherein
the request information is first request information, and
the microprocessor is configured to perform
the generating including, when a second additional request information indicating additional request of the user is acquired after the image is output, updating the image based on second additional request information.

13. An information presentation method comprising:
acquiring request information indicating a request of a user for a service including provision of a merchandise or labor;
when acquiring the request information, acquiring preference information regarding preference of the user for the merchandise or the labor;
generating an image of the merchandise or the labor according to the request of the user based on the preference information acquired; and
outputting the image to a display device.

14. A non-transitory computer-readable storage medium storing an information presentation program for presenting information, the information presentation program configured to be executed by a computer, wherein
the information presentation program causes the computer to perform:
acquiring request information indicating a request of a user for a service including provision of a merchandise or labor;
when acquiring the request information, acquiring preference information regarding preference of the user for the merchandise or the labor;
generating an image of the merchandise or the labor according to the request of the user based on the preference information acquired; and
outputting the image to a display device.
